(19) United States
(12) Patent Application Publication
(10) Pub. No.: US 2002/0069163 A1
(43) Pub. Date: Jun. 6, 2002

(54) Method and system for vertical messaging, billing and payment services

(76) Inventor: Michael H. Gilbert, White Plains, NY (US)

Correspondence Address: Pitney Bowes Inc., Intl Prop Dept, 35 Waterview Drive, P.O. Box 3000, Shelton, CT, 06484, US

(21) Appl. No.: 09/728,152

(22) Filed: Dec. 1, 2000

(51) Int. Cl. G06F 17/60

(52) U.S. Cl. 705/40

(57) ABSTRACT

A method and system for generating and processing billing and payment information for a service provided by service providers in multiple tiers includes collecting usage information of the service by a customer from one of the tiers of the multiple tiers or a third party. The usage information is integrated with customer profile information of the customer provided by a second tier of the multiple tiers. Billing information is generated based on the usage information, the customer profile information, and rate information for the service. A bill based on the generated billing information is transmitted to the customer either using paper mail or by electronic bill presentment. Payments received are processed and allocated based on the payment information.

### BACKGROUND OF THE INVENTION

1. Field of the Invention

This invention relates generally to the field of providing processing services, such as, billing and payment processing services, for services provided by service providers at multiple tiers, such as, energy services offered in a deregulated environment through one or more tiers, for example, a generator, a service company, and a distributor tier.

2. Background of the Related Art

With the growth of the Internet and other communication technologies, a vast new array of services can now be offered to customers. Furthermore, with the growth of vast array of services that can be provided to customers, the supply chain now often includes multiple tiers (so called vertical tiers) to provide the services to the customers in the most cost effective manner such that the different participants in the supply chain can concentrate on providing services based on their core competencies.

For example, energy deregulation has now given rise to enormous complexities in the billing and payment areas related to providing energy services with several different participants in the supply chain. In the past, generally a single entity has provided energy services to a customer. For example, as shown in FIG. 1, a traditional energy company relationship was based on a single entity 100 providing the generation, energy service and transmission to one or more types of customers 101 and 102. Accordingly, if there were N rate plans for C types of customers the total number of billing information permutations was C*N.

The deregulated energy market has broken the traditional utility company into at least three entities: Generation, Distribution (i.e., entities providing the pipes and wires), and Service providers. Each of these entities now must send billing information and collect payments from each other and/or from the ultimate customers (or end users) of the utility services. Therefore, there is now a dramatically increased flow of billing and payment information together with much greater complexities in managing this information. Furthermore, the increase in information flow is geometric, since each energy customer may be able to choose from among several “generators” from whom to buy energy. For example, as shown in FIG. 2, a customer may be able to choose one among several generators 202, several energy services companies 200 and one or more transmission services companies 201. In such a situation, the number of permutations for billing information increase substantially. For example, if there are N rate plans for each Generator G, and each customer can choose one of the G generators, the number of basic bill information permutations is G*C*N. This number is further increased in a geometric progression if the customer can choose one of many energy services companies or if the energy services company has multiple rate plans.

In many states, however, the bill and financial transaction must be produced from one entity, such as the local distribution company that still operates as a monopoly or the energy service company. Therefore, there is a requirement for managing this vast amount of information and billing options from one logical location even through different entities at multiple tiers may collaborate to provide a service to a customer (i.e., the end user). Furthermore, there is a need to need to maximize the use of the information on the customers since the customers may provide a significant amount of information to facilitate integrated billing and payment that manages the complexities associated with this multi-tier service process.

Since all the bills are ultimately derived from a few variables typically acquired from the energy (or electric) meter, there is a need for an integrated billing and messaging service that directly uses the acquired data from the energy meter.

### SUMMARY OF THE INVENTION

Therefore, it is a general object of the invention to alleviate the problems and shortcomings identified above.

In one aspect, the present invention provides for acquiring raw usage data for a service from a meter (such as a meter measuring consumption of energy services) and providing all billing and payment processing services for various service providers across multiple tiers that cooperatively provide the service.

One aspect of the present invention provides a method of generating and processing billing and payment information for a service provided cooperatively by multiple tiers, the method including the steps of: collecting usage information of the service by a customer from either a first tier of the multiple tiers or a third party; integrating usage information with customer profile information for the customer provided by a second tier of the multiple tiers; generating billing information based on the usage information, the customer profile information, and rate information for the service; transmitting a bill based on the billing information to the customer; processing payment information received from the customer; and allocating payments based on the payment information to service providers at the multiple tiers that cooperatively provide the service.

Another aspect of the present invention provides that collecting usage information includes collecting usage information from a distributor of the service that is different from a generator or a provider of the service.

A further aspect of the present invention provides that integrating usage information includes using customer information provided by one of a generator, distributor, or provider of the service.

Another aspect of the present invention provides that generating billing information includes using rate information from one or more of a generator, a distributor, or a provider of the service.

A further aspect of the present invention provides for transmitting the bill to the customer includes generating and mailing a paper bill to the customer.

A further aspect of the present invention provides that transmitting the billing information to the customer includes printing the billing information at an optimal mailing location based on address information of the customer, and mailing the billing information from the optimal mailing location. The optimal mailing location may be determined based on the zip-code of the customer.

Another aspect of the present invention provides that allocating payments includes allocating payments to one or more of a generator, a distributor, or a provider of the service.

In one aspect of the present invention, the service includes an utility service.

In another aspect of the present invention, transmitting a bill to a customer includes electronic bill presentment to the customer using either a public or a private electronic network. The public electronic network may be the Internet.

Another aspect of the present invention includes performing data mining using the usage information, the customer profile information, and the payment information.

In one aspect, the present invention provides is a computer readable medium for generating and processing billing and payment information for a service, the program code including a first program code that collects usage information of the service by a customer from either a first tier of the multiple tiers or a third party; a second program code that integrates usage information with customer profile information for the customer provided by a second tier of the multiple tiers; a third program code that generates billing information based on the usage information, the customer profile information, and rate information for the service; and a fourth program code that transmits a bill based on the billing information to the customer.

In another aspect of the present invention, the first program code collects the usage information from a distributor of the service that is different from a generator or a provider of the service.

In another aspect of the present invention, the second program code integrates usage information with customer profile information provided by one of a generator, a distributor, or a provider of the service.

A further aspect of the present invention provides that the third program code generates billing information using the rate information from one of a generator, a distributor, or a provider of the service.

In one aspect of the present invention, the fourth program code generates a bill based on the billing information. Th bill can be generated as electronic data with billing information suitable for printing, such that the electronic data with billing information can be transmitted to an optimal mailing location for printing and mailing to the customer.

In another aspect, the present invention further includes a fifth program code that processes payment information received from the customer; and a sixth program code that allocates payments based on the payment information.

In a further aspect of the present invention, the fourth program code formats and transmits the billing information for electronic bill presentment to the customer using a public or private electronic network. The public electronic network may be the Internet.

Another aspect of the present invention includes a seventh program code that performs data mining using the usage information, the customer profile information, and the payment information.

A further aspect of the present invention provides a system for generating and processing billing and payment information for a service provided cooperatively by multiple tiers or a third party, the system including computing units connected to a network such that a first computing unit collects usage information of the service by a customer from either a first tier of the multiple tiers or a third party; a second computing unit integrates the usage information with customer profile information for the customer provided by a second tier of the multiple tiers; a third computing unit generates billing information based on the usage information, the customer profile information, and rate information for the service; and a fourth computing unit transmits a bull based on the billing information to the customer.

In another aspect of the present invention, the first computing unit collects the usage information from a distributor of the service that is different from a generator or a provider of the service.

In a further aspect of the present invention, the second computing unit integrates the usage information with the customer profile information provided by one of a generator, distributor, or a provider of the service.

In a another aspect of the present invention, the third computing unit generates billing information using the rate information from one of a generator, a distributor, or a provider of the service.

In another aspect, the present invention provides that the fourth computing unit generates electronic data with billing information suitable for printing and transmits the electronic data with billing information to an optimal mailing location for printing and mailing to the customer.

In a further aspect the present invention includes a fifth computing unit that processes payment information received from a customer; and a sixth computing unit that allocates payments based on the payment information.

In one aspect the present invention provides that the fourth computing unit formats and transmits the billing information for electronic bill presentment using a public or private electronic network. The public electronic network may be the Internet.

In another aspect, the present invention provides a seventh computing unit that is programmed to perform data mining using the usage information, the customer profile information, and the payment information.

### BRIEF DESCRIPTION OF THE DRAWINGS

The accompanying drawings, which are incorporated in and constitute a part of the specification, illustrate a presently preferred embodiment of the invention, and, together with the general description given above and the detailed description of the preferred embodiment given below, serve to explain the principles of the invention.

FIG. 1 is schematic diagram illustrating a traditional energy services configuration in which all aspects of the energy service is provided by one entity.

FIG. 2 is a schematic diagram showing a deregulated energy services configuration in which only some aspects of the energy service are provided by one entity.

FIG. 3 shows a block diagram showing the components of a general purpose computer system connected to an electronic network.

FIG. 4 shows a block diagram of the billing and payment system according to one embodiment of the present invention.

FIGS. 5A and 5B show process flows for two embodiments of the present invention.

FIG. 6 is a block diagram illustrating another embodiment of the present invention.

### DESCRIPTION OF THE PREFERRED EMBODIMENT(S)

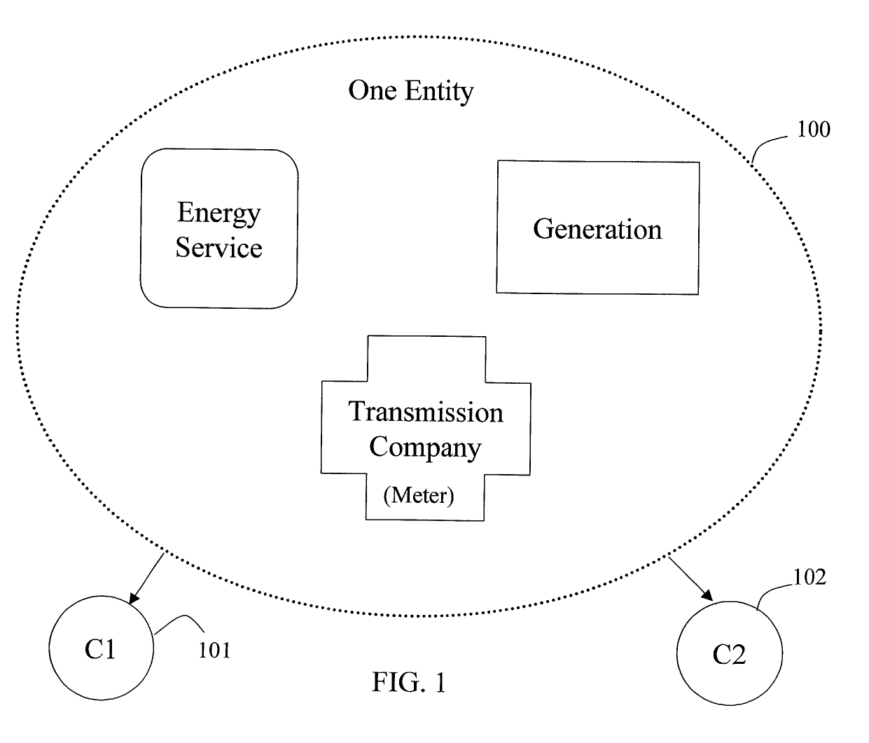

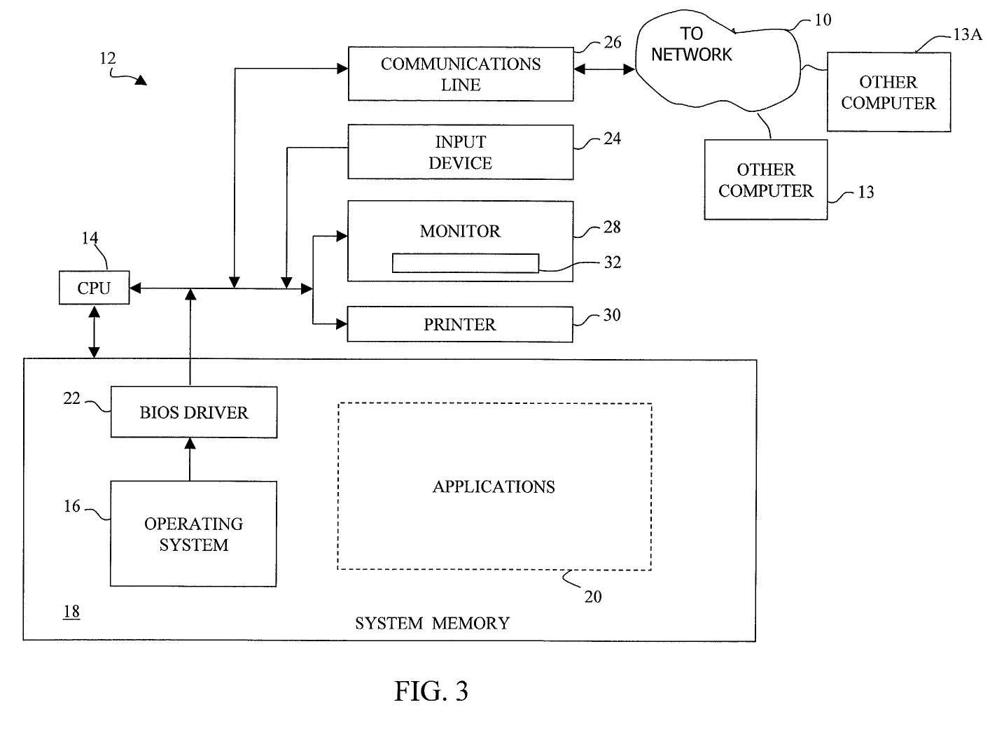

With reference to the figures, FIG. 3 is a block diagram showing the components of a general purpose computer system 12 connected to an electronic network 10, such as a computer network. The computer network can also be a public network, such as the Internet, a private network or a virtual private network. As shown in the FIG. 1, the computer system 12 includes a central processing unit (CPU) 14 connected to a system memory 18. The system memory 18 typically contains an operating system 16, a BIOS driver 22, and application programs 20. In addition, the computer system 12 contains input devices 24 such as a mouse and a keyboard 32, and output devices such as a printer 30 and a display monitor 28.

The computer system generally includes a communications interface 26, such as an ethernet card, to communicate to the electronic network 10. Other computer systems 13 and 13A also connect to the electronic network 10 which can be implemented as Wide Area Network (WAN) or as an inter-network such as the Internet. One of skill in the art would recognize that the above system describes the typical components of a computer system connected to an electronic network. It should be appreciated that many other similar configurations are within the abilities of one skilled in the art and all of these configurations could be used with the methods of the present invention. Furthermore, it should be recognized that the computer system and network disclosed herein can be programmed and configured as computing units, by one skilled in the art, to implement the method steps discussed further herein.

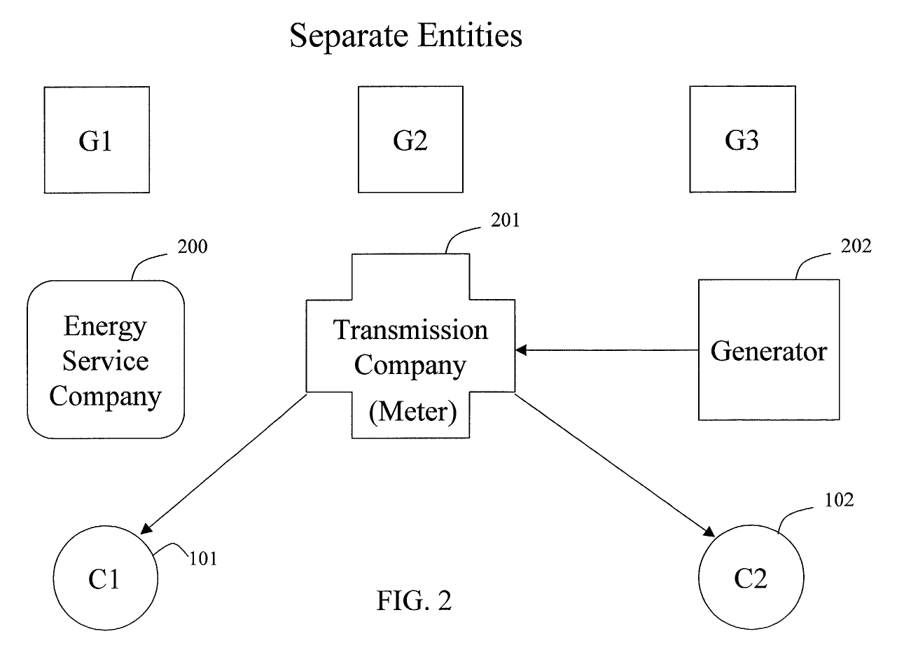

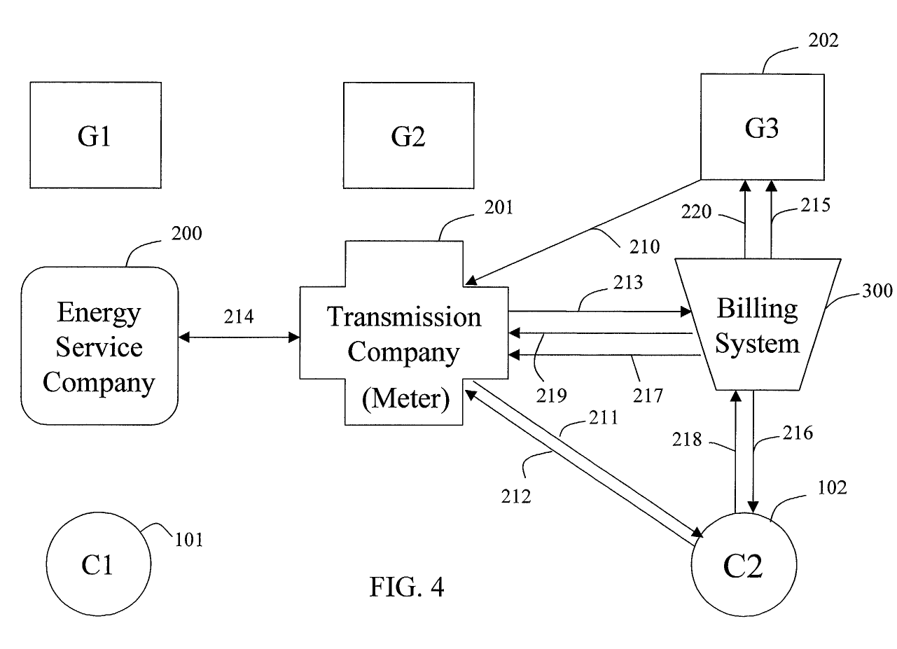

As shown in FIG. 4, the present invention provides a computer network implemented system (including related hardware and programmed software grouped into suitable interconnected computing units) that provides for integrated billing and payment processing for a multi-tiered service offered to customers. An example of such a multi-tiered service is the provision of energy services in a deregulated environment in which several different entities are involved in the provision of energy services to the customer. Therefore, in this embodiment, an energy services company 200 provides energy services to a customer 102 through a transmission company 201. The energy services company 200 may not generate all the energy (for example, electricity) that it provides the customer. Rather the energy may be generated by a separate generation company 202 which directly provides the energy to the customer 102 through the transmission company 201 (as shown in FIG. 2). For example, the energy services company 200 may not provide energy at all. Rather, it may only provide services such as maintenance contracts, energy commodity, price insurance, or other services that are ancillary to the provision of energy. Of course, the charges for provision of such ancillary services may be included in the energy bill with the charges for such ancillary services being allocated from the payment received from the customer or end user of the energy services.

According to the present invention, the billing and payment processing services are provided by a separate system 300 that integrates all the various choices that can be made by a customer and also provide sufficient information to each of the companies involved in the service delivery to the customer 102.

It should be understood that the preferred embodiment contemplates that the billing and payment are provided by the separate system 300 (preferably in a separate company or entity). However, the functionality of the system 300 can also be provided by one or more of the companies in any one of the other tiers. That is the billing and payment service provided according to the present invention could also be provided by any one of the energy services company 200, the transmission company 201, the generation company 202, or an unrelated third party entity.

As shown in FIG. 4, the preferred embodiment contemplates that the generator 202 provides the energy directly to transmission company 201 (see energy flow 210) so that the transmission company can provide the energy directly to the customer 102 (see energy flow 211). Raw information related to energy consumption (for example, based on meter readings) is provided from the customer 102 to the transmission company 201 (see raw information flow 212) and from the transmission company 201 to the billing and payment system 300 (see raw information flow 213). It should be noted that the raw data from the meter readings may be obtained from a third party or may be directly provided to the billing system provider 300.

In an important aspect of the present invention, the billing system 300 acquires the raw electronic data from the meter (for example, as a direct electronic data feed) and accesses all other data required to completely manage the billing and payment allocation (as well as other services as discussed further herein) required across all tiers of the multiple tiers cooperating to provide the energy service.

The billing and payment services system 300 also receives customer and billing information from one or both of the energy services company 200 and the transmission company 201 (see, for example, flows 214 and 213). The customer information includes customer profile information, such as, for example, identification, location, demographic, and facility information associated with the customer. Other examples of customer information include customer account number(s), address, service type, generator or service options, rate plan(s), billing preference (paper or electronic), and other enrollment information. The billing information includes, for example, various rate plans by location, taxes, surcharges, service charges, as well as any local regulatory charges.

It is to be understood that the energy services company 200 and the transmission company 201 are examples of two tiers cooperating to provide energy services to a customer. The present invention also contemplates more than two tiers cooperating to provide a service, such as energy service, to a customer. Furthermore, third parties, such as a separate metering company, can also provide input to the billing and payment services system 300 in one embodiment of the present invention.

It should also be understood that billing and payment processing services are one example of other processing services that may be provided, either alone or in combination, using the system and method of the present invention. Other examples of processing services that could be provided to multiple tiers cooperating to provide a service to a customer includes, for example, services related to customer enrollment, inventory management, new products, customer relationship management, or maintenance services. Furthermore, in one embodiment, the billing information need not be calculated from meter data, rather, it can also be computed based on a contract or schedule which determines the amount to be billed without any calculations based on meter data. For example, billing information for lights in a parking garage may be fixed by contract without the need for meter data generation or collection.

As part of the billing services, the billing and payment services system 300 provides processed information, such as the bill 216 to the customer 102, and appropriate processed information, as shown by the information flows 215 and 217, to the generation company 202 and the transmission company 201, respectively. Furthermore, even though not shown in the FIG. 4, the present invention contemplates that the billing and payment services system 300 can also provide processed information directly to the energy services company 200 in one embodiment of the present invention.

The payment information (included, for example, with the payment itself) may be provided from the customer to the billing and payment services system 300 (see flow 218) for allocation and distribution to the transmission company 201 (see flow 219), to the generation company 202 (see flow 220), and/or the energy service company 200. Therefore, the present invention provides a centralized billing and payment system 300 that processes all the information from a variety of data sources (including, for example, raw usage data provided from a meter reading) relating to provision of a service including components provided by different companies at multiple tiers that collaborate to effectively provide the service to the customer (or end user). It is also to be understood that the present invention utilizes known security measures for transmission of electronic data across networks. Therefore, encryption, authentication, verification, and other security measures for transmission of electronic data are used using techniques that are well known to those skilled in the art.

One of skill in the art would recognized that the “centralized” billing and payment system refers to a logically centralized system that receives all the service delivery information and payment information to provide billing and payment processing services. One skilled in the art would recognize that such a centralized system could easily be implemented using a physically distributed system in which one or more processors and databases are connected over a computerized network, and suitable hardware and programmed software is provided to coordinate the processors, databases, and networks to provide the functionalities disclosed herein.

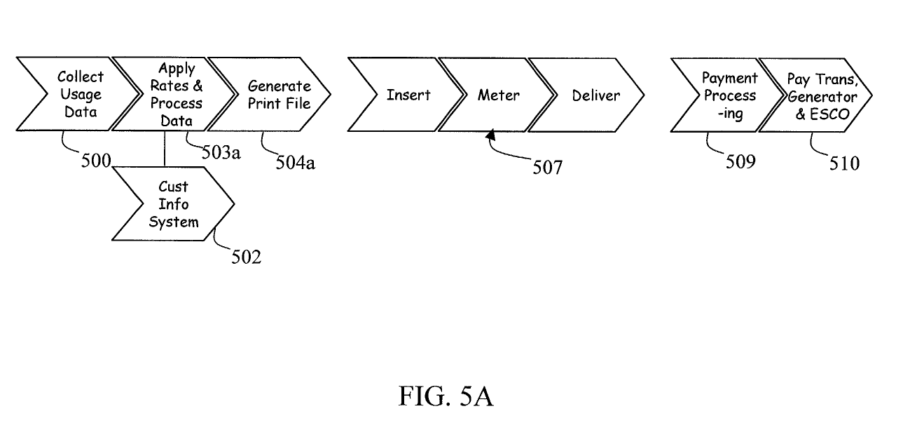

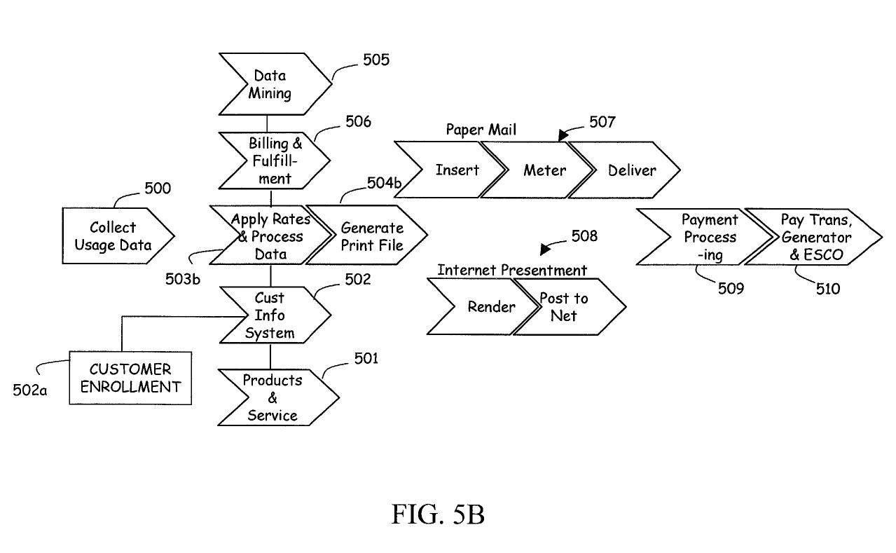

FIGS. 5A and 5B show the process flows of two embodiments of the present invention. FIG. 5B illustrates the functions performed by one of the two embodiments of the present invention and compares the additional functionalities to the functionalities shown in FIG. 5A corresponding to the other of the embodiments discussed above with respect to FIG. 4. The embodiment shown in FIG. 5B shows that the utility company 200 or 201 (or a third party provider of such data) provides the usage or consumption data while all the remaining functionality is provided by the billing and payment services system 300 of the present invention (which may be provided, for example, by a separate provider of computerized information services (CIS)). Therefore, in step 500, the usage information is collected by either one of the energy service company 200, the transmission company 201, or a third party that collects such information (i.e. a meter reading entity), and provided to the billing and payment services system 300.

The billing and payment services system 300, according to this embodiment of the present invention, accesses the products and services related to the energy services in step 501 and the customer information (as discussed earlier herein) in step 502. As discussed earlier, the products and services and the customer records can be originated by one or more of the companies at one or more tiers that combine to provide the energy services. Examples of such products and services include, for example, energy commodity marketing, hedging prices, service or preventive maintenance contracts on energy equipment such as lights, HVAC, and other services that are ancillary to providing energy services.

Therefore, the energy services companies, the transmission companies, as well as the generation companies may have each customer information and products and services information. This information is accessed or stored by the billing and payment services system 300 of the present information. Such access can be implemented in several ways. For example, each of the companies in the various tiers can provide data feeds, either in batch or online mode, so that the information can be stored by the billing and payment services system 300. Alternatively, some of the data may be stored by companies in the various tiers and this data may be accessed by the billing and payment services company 300 in either a batch or online mode. Furthermore, one of skill in the art would recognize that data required for constructing historical bills could be archived such that any required bills could be generated on-line if required. Such an on-demand generation of historical bills would prevent the need for storing large quantities of historical bills which may only be infrequently accessed.

Other functions that are provided by the billing and payment services system include data mining in step 505. The data mining functionality can be used both for cross-selling other items or services to the customers or for providing more efficient and better delivery of services to the customers. Some of the exemplary data mining functions that can be provided include forming associations based on the database of transactions. For example, one set of information in a transaction may imply the presence of another set of items. For example, consumption patterns may correlate to bill payment habits.

Another data mining function can include classification in which customers can be classified into categories based on some attributes of customer or transaction information. Another data mining functionality can include detecting sequential patterns in transactions so that these patterns can be used for predictive purposes.

All of these “mined” information or patterns can be used for a variety of purposes including cross-selling, better delivery of services and maximizing the efficiency of production or delivery resources. In addition, this information could be used for predictive purposes to improve marketing, hedging, and better using power futures transactions to decrease cost and risk.

Another feature of the present invention provides a customer enrollment process 502a that provides for customer related information to entered and transmitted to a customer information system 502 so that the customer information can be used to generate the billing information. According to the present invention, the customer enrollment function can be carried out any more than one of the multiple tiers that cooperate to provide the energy service to a customer. The customer information system 502 either stores or is configured to access the customer information from the customer enrollment process irrespective of which tier enrolls the customer.

In step 506, the billing and fulfillment functions include conventional accounting and book keeping processing (and their corresponding data processing steps) that tracks, for example, accounts receivables for each customer, and provides the information that can be used for tracking and allocating payments that are subsequently received from a customer.

As shown in FIGS. 5A and 5B, in steps 503a and 503b, the rates and process data (as derived from the function steps described earlier) is used along with the customer information to actually generate the bills for the customers. The bill is generated typically in electronic format in steps 504a and 504b. One important aspect of the present invention is that the process in step 503b applies the rates corresponding to any and all of the tiers cooperating to provide the energy service and computes billing information by integrating the various rate information of the service providers in the multiple tiers with the customer information. The customer information may include which rate plan(s) and service provider(s) a customer is using for his service. Thereafter, the bill is prepared for presentation to the customer.

One method of bill presentment 507 includes generating paper bills that are then sent by paper mail to the addresses of the customers. When sending paper bills, the printing can be optimized for efficient billing by, for example, generating bills at mailing centers that are closest to the customers to result in lowest mailing costs and/or fastest delivery and/or lower pollution by transportation for mailing to the customers. In one embodiment, this can be accomplished by using the zip codes or other address related information to generate the paper bills at mailing centers based on optimizations for cost or other delivery related criteria, such as, mailing capacity, environmental impact, or the like.

Another method of bill presentment, according to the present invention as shown in step 508, includes Internet presentment in which the bill is generated in a web enabled format so that it can be posted to an appropriate website. This web site can be a website associated with the billing and payment services system 300 or it can be a website of any one of the companies at any of the vertical tiers that cooperated to provide the energy service to the customer. Furthermore, the electronic bill may be sent, as an attachment, by electronic mail to the customer. Alternatively, an electronic mail notification can be sent to client with a link (such as a HTML hyperlink) that links to the electronic format of the bill accessible via an electronic network such as the Internet. In addition, the electronic bill presentment contemplates that the customer is provided the option of paying the bill online by using a secure payment mechanism as is well known to those skilled in the art.

Furthermore, an alternate embodiment of the present invention contemplates that the billing and payment services system 300 of the present invention cooperates with a third party electronic or web based payment service so that the suitably formatted electronic bill can be accessed from the website or other interface to the third party billing service.

In another embodiment of the present invention, it is contemplated that the bill presentment can be optimized based on customer related or other factors. Therefore, bill presentment can be customized based on factors such as, for example, payment habits, special payment plans, payment mechanism (check, EFT, etc.), presentment media preference (paper or electronic), voice or braille presentment, or any other multi-media bill presentment Therefore, different methods of bill presentment or more than one type of bill presentment may be used for a customer based on customer preference or based on whether, for example, a customer is associated with a third party bill payment system.

In addition, bill presentment may also be optimized for efficiency reasons. For example, bills may be presented on websites based on geographical locations of the customers. Furthermore, it should be understood that while the preferred embodiment refers to “Internet” bill presentment, the present invention also envisages that other private or public networks can be used for bill presentment. Also, in addition to web based interfaces, other access technologies, protocols, and user interfaces may also be used. For example, bills may be produced for any presentment media.

It should be understood that, in the preferred embodiment, each customer is provided with one consolidated bill for an energy service irrespective of the combination of companies at the various tiers that the customer may have selected to provide the various services. However, in one preferred embodiment, the bill could break out the charges by each provider or even generate separate bills for each provider. For example, such a break out of charges by provider may be useful to a customer to determine the most optimal combination of providers for a particular energy service and usage.

In addition the present invention provides for the processing of both electronic and paper payments received from the customers. Therefore, the present invention contemplates that the payments received from customers can be automatically allocated among the various providers based on information that is used to generate the consolidated bill for services provided by each of the providers.

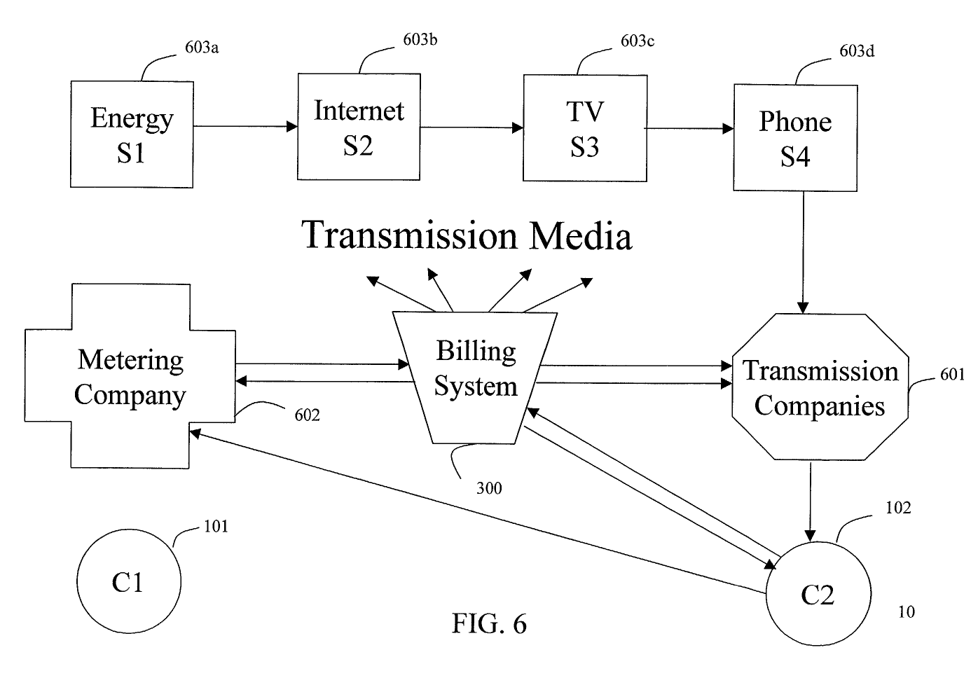

As shown in FIG. 6, the present invention also contemplates that one or more services can be provided by the system and method of the present invention. Therefore, the billing and payment services system 300 cooperates with multiple tiers (for example, transmission companies 601, metering companies 602, or a generation company) that generates or delivers one or more services to the customer 102. Where multiple services are provided, the different types of services offered may include, for example, energy 603a, Internet service or internet based services 603b, television 603c (including cable and satellite), and telephone 603d, as well as value added services provided on these services. In addition, the multiple services provided can also include the provision of gas and water and value added services related to the provision of gas and water. In addition, the system 300 provides billing and payment for services provided on a variety of transmission media (including wireline, wireless, broadband, satellite, etc.). The system provides billing and payment services that account for services in which multiple companies cooperate across multiple tiers (typically vertical tiers) to provide the service to a customer and where one integrated bill may be presented to the customer.

It should be understood that the preferred embodiment of the present invention relates to providing billing and payment processing services. However, other value services, for example, as discussed earlier with respect to component 501, could also be provided using the present invention for multiple services.

Some of the benefits of the present invention include that a specialized system manages the increasing complexity of billing and payment processing as more tiers and relationships between the tiers is added. Each of the entities in the various tiers can concentrate on their core competencies without having to worry about developing sophisticated processing services for the increasingly complex relationships between entities cooperating to provide services to customers. Furthermore, additional information across the tiers is accessible by, for example, the data mining process, so that additional services and efficiencies can be developed using this information. The customers benefit by receiving one (or a fewer number) of integrated bills which provide them valuable information to optimize their selection of providers in each tier in a vertical multi-tier service. The present invention also provides that the processing services can also be provided for many different services so that customers need to only interact with a single provider of processing services for these different services. The different service providers can elect to bundle their billings in any suitable aggregation. Another advantage provided by the present invention is that by working from a standard set of raw data.

Other embodiments of the invention will be apparent to those skilled in the art from a consideration of the specification and the practice of the invention disclosed herein. It is intended that the specification be considered as exemplary only, with the true scope and spirit of the invention being indicated by the following claims.

What is claimed is:

1. A method of generating and processing billing and payment information for a service provided cooperatively by multiple tiers, the method comprising the steps of:
collecting usage information of the service by a customer from one of a first tier of the multiple tiers or a third party;
integrating usage information with customer profile information of the customer provided by a second tier of the multiple tiers;
generating billing information based on the usage information, the customer profile information, and rate information for the service; and
transmitting a bill based on the billing information to the customer.

2. The method according to claim 1, wherein the first tier includes a distributor of the service that is different from a generator or a provider of the service.

3. The method according to claim 1, wherein the step of integrating usage information includes using customer profile information provided by the second tier that includes one of a generator, a distributor, or a provider of the service .

4. The method according to claim 1, wherein the step of generating billing information includes using rate information from at least one of a generator, a distributor, or a provider of the service.

5. The method according to claim 1, wherein the step of transmitting the bill to the customer includes generating and mailing a paper bill to the customer.

6. The method according to claim 5, wherein the step of transmitting the bill to the customer includes the steps of:
printing the bill at an optimal mailing location based on address information of the customer; and
mailing the bill from the optimal mailing location.

7. The method according to claim 6, wherein the optimal mailing location is determined based on at least one of a zip-code of the customer, a transportation cost, an environmental impact, or a mailing capacity of a mail distribution center.

8. The method according to claim 1, further comprising the steps of:
processing payment information received from the customer; and
allocating payments, based on the payment information, to pay service providers at the multiple tiers from the payment information received from the customer.

9. The method according to claim 8, wherein the step of allocating payments includes allocating payments to one or more of a generator, a distributor, or a provider of the service.

10. The method according to claim 1, wherein the service includes utility service.

11. The method according to claim 10, wherein the utility service includes one of power, water, gas, cable television, telephone, internet, or satellite television services.

12. The method according to claim 1, wherein the step of transmitting the bill to the customer includes electronic bill presentment to the customer using a public or private electronic network.

13. The method according to claim 12, wherein the public electronic network includes the Internet.

14. The method according to claim 1, wherein the step of transmitting the bill to the customer includes providing the billing information to a third party bill payment service.

15. The method according to claim 8, wherein the step of processing payment information includes using a third party authentication or verification service.

16. The method according to claim 1, further comprising the step of performing data mining using the usage information and the customer profile information.

17. The method according to claim 8, further comprising the step of performing data mining using the usage information, the customer profile information and the payment information.

18. The method according to claim 17, further comprising the step of using results of the data mining step to determine which additional services to offer to the customer.

19. The method according to claim 1, wherein the step of collecting usage information includes receiving a direct feed of raw data from a metering company.

20. A method of providing processing services for a service provided cooperatively by multiple tiers, the method comprising the steps of:
collecting usage information of the service by a customer from one of a first tier of the multiple tiers or a third party;
correlating the usage information with a customer profile information for the customer provided by a second tier of the multiple tiers;
processing the usage information and the customer profile information to generate processing service information; and
delivering the processing service information to the customer including processing service information related to the first tier and the second tier.

21. A method of providing processing services for multiple services provided, each provided cooperatively by multiple tiers, comprising the steps of:
collecting usage information of the multiple services by a customer from one of a respective first tier of the multiple tiers or a respective third party;
correlating the respective usage information and the respective customer profile information from a respective second tier of the multiple tiers;
processing the usage information and the customer profile information to generate integrated processing services information; and
delivering the integrated processing services information to the customer.

22. A computer readable data storage medium having program code recorded thereon for generating and processing billing and payment information for a service provided cooperatively by multiple tiers, the program code comprising:
a first program code that collects usage information of the service by a customer from one of first tier of the multiple tiers or a third party;
a second program code that integrates usage information with customer profile information for the customer provided by a second tier of the multiple tiers;
a third program code that generates billing information based on the usage information, the customer profile information, and rate information for the service; and
a fourth program code that transmits a bill based on the billing information to the customer.

23. The computer readable data storage medium according to claim 22, wherein the first program code collects the usage information from the first tier that includes a distributor of the service that is different from a generator or a provider of the service.

24. The computer readable data storage medium according to claim 22, wherein the second program code integrates usage information using customer profile information provided by one of a generator, a distributor, or a provider of the service.

25. The computer readable data storage medium according to claim 22, wherein the third program code generates billing information using the rate information from one of a generator, a distributor, or a provider of the service.

26. The computer readable data storage medium according to claim 22, wherein the fourth program code generates electronic data with billing information suitable for printing, and transmits the electronic data with billing information to an optimal mailing location for printing and mailing to the customer.

27. The computer readable data storage medium according to claim 22, further comprising a fifth program code that processes payment information received from the customer; and
a sixth program code that allocates payments to service providers at the multiple tiers based on the payment information.

28. The computer readable data storage medium according to claim 22, wherein the fourth program code transmits the billing information for electronic bill presentment to the customer using a public or private electronic network.

29. The computer readable data storage medium according to claim 28, wherein the public electronic network includes the Internet.

30. The computer readable data storage medium according to claim 27, further comprising a seventh program code that performs data mining using the usage information, the customer profile information, and the payment information.

31. A system for generating and processing billing and payment information for service provided cooperatively by service providers at multiple tiers, the system including computing units connected to a network, the system comprising:
a first computing unit that collects usage information of the service by a customer from one of a first tier of the multiple tiers or a third party;
a second computing unit that integrates the usage information with customer profile information for the customer provided by a second tier of the multiple tiers;
a third computing unit that generates billing information based on the usage information, the customer profile information, and rate information for the service; and
a fourth computing unit that transmits a bill based on the billing information to the customer.

32. The system according to claim 31, wherein the first computing unit collects the usage information from the first tier that includes a distributor of the service that is different from a generator or a provider of the service.

33. The system according to claim 31, wherein the second computing unit integrates the usage information with customer profile information provided by one of a generator, distributor, or a provider of the service.

34. The system according to claim 31, wherein the third computing unit generates billing information using the rate information from one of a generator, a distributor, or a provider of the service.

35. The system according to claim 31, wherein the fourth computing unit generates electronic data with billing information suitable for printing and transmits the electronic data with billing information to an optimal mailing location for printing and mailing to the customer.

36. The system according to claim 31, further comprising:
a fifth computing unit that processes payment information received from a customer; and
a sixth computing unit that allocates payments between service providers at the multiple tiers based on the payment information.

37. The system according to claim 31, wherein the fourth computing unit transmits the billing information for electronic bill presentment using a public or private electronic network.

38. The system according to claim 37, wherein the public electronic network includes the Internet.

39. The system according to claim 36, further comprising a seventh computing unit that is programmed to perform data mining using the usage information, the customer profile information, and the payment information.

40. The system according to claim 36, wherein the payment information is either received electronically or extracted from a paper based payment.
